(19) United States
(12) Patent Application Publication
(10) Pub. No.: US 2025/0026404 A1
(43) Pub. Date: Jan. 23, 2025

(54) FOUR-WHEELED TRAVELING DEVICE

(71) Applicant: HAKOBOT INC., Miyazaki-shi, Miyazaki (JP)

(72) Inventors: Yoshihiro HIRATA, Tokyo (JP); Yuki HASEGAWA, Tokyo (JP)

(73) Assignee: HAKOBOT INC., Miyazaki-shi, Miyazaki (JP)

(21) Appl. No.: 18/714,428

(22) PCT Filed: Nov. 24, 2022
(86) PCT No.: PCT/JP2022/043267

§ 371 Date: May 29, 2024

(30) Foreign Application Priority Data
Nov. 29, 2021 (JP) 2021-193118

(51) Int. Cl. B62D 7/14

(52) U.S. Cl. CPC B62D 7/14

(57) ABSTRACT

A four-wheel traveling device having a new steering mechanism performs steering by converting an extending/retracting motion of one linear actuator into rotational motion in the horizontal plane of a first front wheel, a second front wheel, a first rear wheel, and a second rear wheel via a link, wherein the linear actuator extends and retracts parallel to a line connecting the first front wheel and the second front wheel.

### TECHNICAL FIELD

The present invention relates to a four-wheeled traveling device.

### BACKGROUND ART

Patent Literature 1 discloses a steering device for a traveling vehicle.

### CITATION LIST

### Patent Literature

Patent Literature 1: Japanese Patent No. 4109361

### SUMMARY OF INVENTION

### Technical Problem

An object of the present invention is to provide a four-wheeled traveling device having a new steering mechanism.

### Solution to Problem

According to one embodiment, provided is a four-wheeled traveling device that performs steering by converting extension and contraction motion of one linear actuator into rotational motion of a first front wheel, a second front wheel, a first rear wheel, and a second rear wheel in a horizontal plane via a link, wherein the linear actuator extends and contracts in parallel with a line connecting the first front wheel and the second front wheel.

Here, the first front wheel, the second front wheel, the first rear wheel, and the second rear wheel are, for example, a left front wheel, a right front wheel, a left rear wheel, and a right rear wheel, respectively. The linear actuator extends and contracts in parallel with the line connecting the left front wheel and the right front wheel, so that the four-wheeled traveling device can be downsized.

According to one embodiment, provided is a four-wheeled traveling device that performs steering by converting extension and contraction motion of one linear actuator into rotational motion of a first front wheel, a second front wheel, a first rear wheel, and a second rear wheel in a horizontal plane via a link, wherein at least two of a link for the first front wheel, a link for the second front wheel, a link for the first rear wheel, and a link for the second rear wheel have an identical shape.

The link for the first front wheel, the link for the second front wheel, the link for the first rear wheel, and the link for the second rear wheel all may have an identical shape.

Here, the first front wheel, the second front wheel, the first rear wheel, and the second rear wheel are, for example, a left front wheel, a right front wheel, a left rear wheel, and a right rear wheel, respectively. At least two (preferably, all four) of the link for the left front wheel, the link for the right front wheel, the link for the left rear wheel, and the link for the right rear wheel have the same shape, so that the manufacturing cost can be reduced.

According to one embodiment, provided is a four-wheeled traveling device that performs steering by converting extension and contraction motion of one linear actuator into rotational motion of a first front wheel, a second front wheel, a first rear wheel, and a second rear wheel in a horizontal plane via a link, wherein a link for the first front wheel and a link for the first rear wheel are located substantially on a first horizontal plane and rotate in the first horizontal plane, a link for the second front wheel and a link for the second rear wheel are located substantially on a second horizontal plane and rotate in the second horizontal plane, and the first horizontal plane and the second horizontal plane are different from each other.

Here, the first front wheel, the second front wheel, the first rear wheel, and the second rear wheel are, for example, a left front wheel, a right front wheel, a left rear wheel, and a right rear wheel, respectively. The link for the left front wheel and the link for the left rear wheel rotate in the same horizontal plane, and the link for the right front wheel and the link for the right rear wheel rotate in the same horizontal plane different from the above horizontal plane, so that the four-wheeled traveling device can be downsized.

The four-wheeled traveling device may comprise: the first front wheel; the second front wheel; the first rear wheel located behind the first front wheel; the second rear wheel located behind the second front wheel; the linear actuator; and the link, wherein the link includes a first link for the first front wheel, a second link for the second front wheel, a third link for the first rear wheel, and a fourth link for the second rear wheel.

The linear actuator may have a rod that extends and contracts in a predetermined direction, the four-wheeled traveling device may comprise a bridge that moves in the predetermined direction in conjunction with the rod, the first link and the third link may rotate in a horizontal plane in conjunction with the extension and contraction of the linear actuator by a first shaft provided in the rod, and the second link and the fourth link rotate in a horizontal plane in conjunction with the extension and contraction of the linear actuator by a second shaft provided in the bridge.

A slit may be provided in each of the first link and the third link, and the first shaft may be slidably fitted into the slits of the first link and the third link.

A slit may be provided in each of the second link and the fourth link, and the second shaft is slidably fitted into the slits of the second link and the fourth link.

The slit may extend in parallel with a line connecting the first front wheel and the first rear wheel in a state of traveling straight.

Each of the first to fourth links may be provided with a small hole into which a third shaft that does not interlock with the rod is fitted, and each of the first to fourth links rotates in a horizontal plane about the small hole.

The linear actuator may be disposed closer to the first front wheel and the first rear wheel than a line connecting centers of the first front wheel and the second front wheel and centers of the first rear wheel and the second rear wheel, when the rod of the linear actuator is at a reference position, the four-wheeled traveling device may travel straight, when the rod of the linear actuator extends from the reference position, the four-wheeled traveling device may bend toward the second front wheel and the second rear wheel, and when the rod of the linear actuator contracts from the reference position, the four-wheeled traveling device may bend toward the first front wheel and the first rear wheel.

As an specific example, the linear actuator is disposed at the left side, when the rod of the linear actuator is at a reference position, the four-wheeled traveling device travels straight, when the rod of the linear actuator extends from the reference position to the right, the four-wheeled traveling device bends toward the right direction, and, when the rod of the linear actuator extends from the reference position to the left, the four-wheeled traveling device bends toward the left direction.

The four-wheeled traveling device may comprises: a camera; and a controller that automatically controls the extension and contraction of the linear actuator based on an image of the camera.

### BRIEF DESCRIPTION OF DRAWINGS

FIG. 1 is a diagram schematically illustrating map information.

FIG. 2 is a functional block diagram of a four-wheeled traveling device according to an embodiment.

FIG. 3A is a schematic top view of main parts of the four-wheeled traveling device according to the embodiment (at the time of traveling straight).

FIG. 3B is a schematic top view of main parts of the four-wheeled traveling device according to the embodiment (at the time of turning right).

FIG. 3C is a schematic top view of main parts of the four-wheeled traveling device according to the embodiment (at the time of turning left).

FIG. 4A is a schematic top view of a floor plate 2, an actuator 3, a floor plate 2, a bridge 4, and a mount 5 (at the time of traveling straight).

FIG. 4B is a schematic top view of the floor plate 2, the actuator 3, the floor plate 2, the bridge 4, and the mount 5 (at the time of turning right).

FIG. 4C is a schematic top view of the floor plate 2, the actuator 3, the floor plate 2, the bridge 4, and the mount 5 (at the time of turning left).

FIG. 5A is a schematic perspective view of the floor plate 2, the actuator 3, the floor plate 2, the bridge 4, and the mount 5 (at the time of traveling straight).

FIG. 5B is a schematic perspective view of the floor plate 2, the actuator 3, the floor plate 2, the bridge 4, and the mount 5 (at the time of turning right).

FIG. 5C is a schematic perspective view of the floor plate 2, the actuator 3, the floor plate 2, the bridge 4, and the mount 5 (at the time of turning left).

FIG. 6A is a schematic perspective view of a link 6FL, a tie rod 7FL, and a knuckle 8FL for a left front wheel 1FL (at the time of traveling straight).

FIG. 6B is a schematic perspective view of the link 6FL, the tie rod 7FL, and the knuckle 8FL for the left front wheel 1FL (at the time of turning right).

FIG. 6C is a schematic perspective view of the link 6FL, the tie rod 7FL, and the knuckle 8FL for the left front wheel 1FL (at the time of turning left).

FIG. 7 is a schematic perspective view of a motor 10FL, a gear box 11FL, a king pin 12FL, a suspension arm 13FL, and a suspension 14FL for the left front wheel 1FL.

FIG. 8 is a diagram schematically illustrating a relation between extension and contraction of a rod 32 and a traveling direction of the four-wheeled traveling device.

### DESCRIPTION OF EMBODIMENTS

Hereinafter, an embodiment according to the present invention will be specifically described with reference to the drawings.

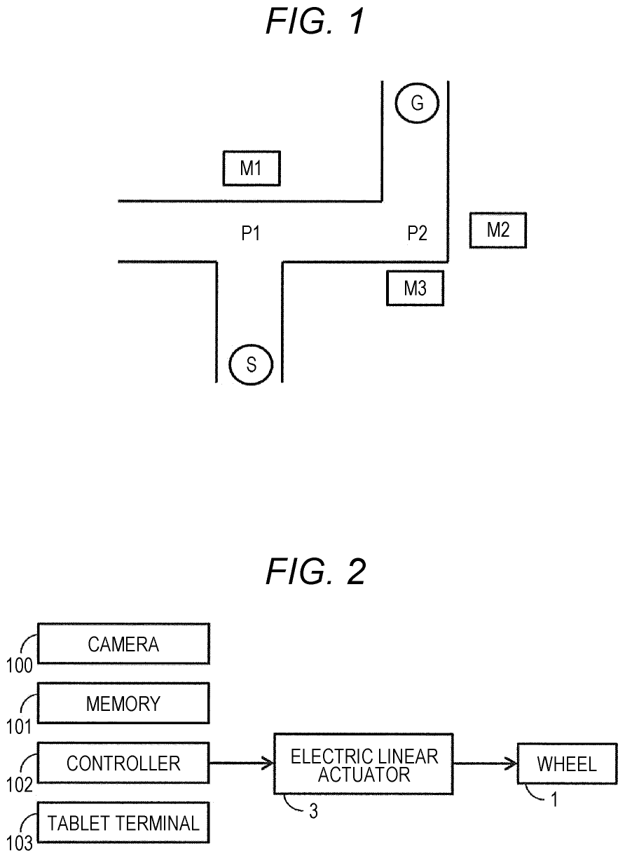

In the present embodiment, a four-wheeled traveling device that self-travels based on map information will be exemplified. As illustrated in FIG. 1, the map information includes position information of markers M1 to M3 (for example, AR markers) installed in advance on a wall, a ceiling, a floor, and the like, in addition to a departure point S and a destination G. These markers are used for the four-wheeled traveling device to grasp an own position.

FIG. 2 is a functional block diagram of the four-wheeled traveling device according to the embodiment. The four-wheeled traveling device includes a camera 100, a memory 101, a controller 102, a tablet terminal 103, an electric linear actuator 3, a wheel 1 (generic term for a left front wheel, a right front wheel, a left rear wheel, and a right rear wheel), and the like.

The camera 100 is provided on a front surface, a rear surface, a left side surface, and a right side surface of the four-wheeled traveling device. The memory 101 stores map information (FIG. 1) that can be set by a user through the tablet terminal 103 as a user interface. The controller 102 performs steering based on an image of the camera 100 and the map information. Specifically, the controller 102 detects the markers M1 to M3 in the map information from the image of the camera 100, and grasps the own position of the four-wheeled traveling device. Then, the controller 102 controls a direction of the wheel 1 by extending and contracting the electric linear actuator 3 so as to reach the destination G from the departure point S.

For example, in FIG. 1, when the marker M1 is detected from the image of the camera 100 provided on the front surface, the controller 102 grasps that the own position is P1. Then, the controller 102 performs steering such that the four-wheeled traveling device turns right. Thereafter, when the marker M2 is detected from the image of the camera 100 provided on the front surface and the marker M3 is detected from the image of the camera 100 provided on the right side surface, the controller 102 grasps that the own position is P2. Then, the controller 102 performs steering such that the four-wheeled traveling device turns left. In this way, the four-wheeled traveling device self-travels from the departure point S to the destination G.

In addition, a distance measuring sensor such as an ultrasonic sensor or a laser may be provided in the four-wheeled traveling device (for example, three points of the front surface, the left side surface, and the right side surface), and the movement of the four-wheeled traveling device may be stopped when an object is detected nearby.

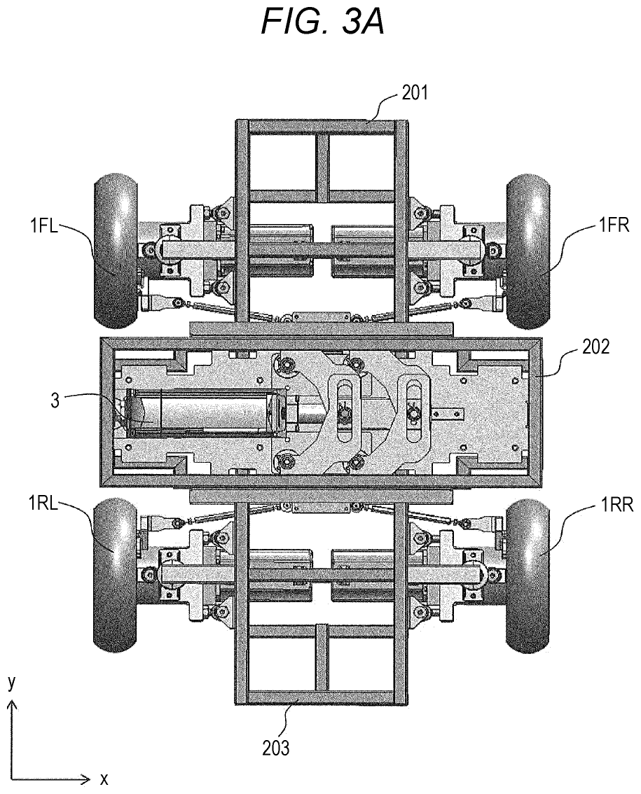

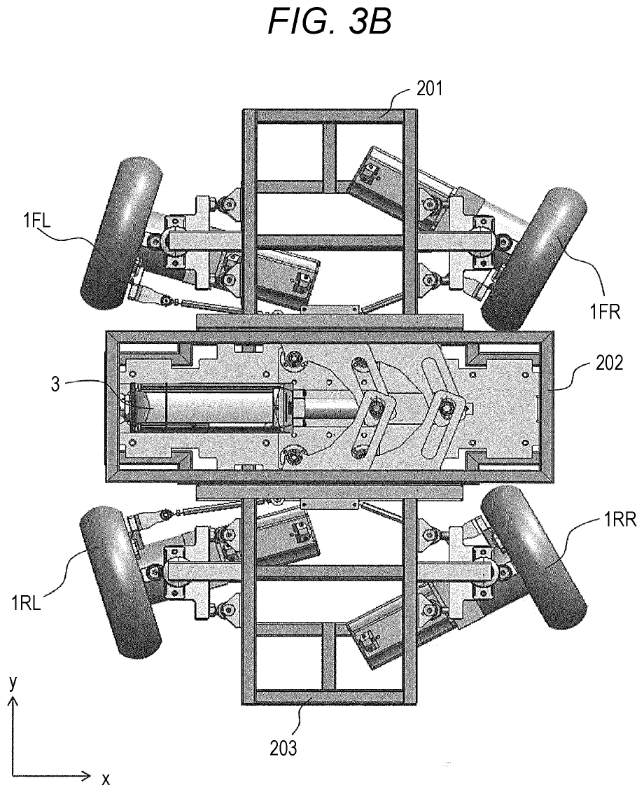

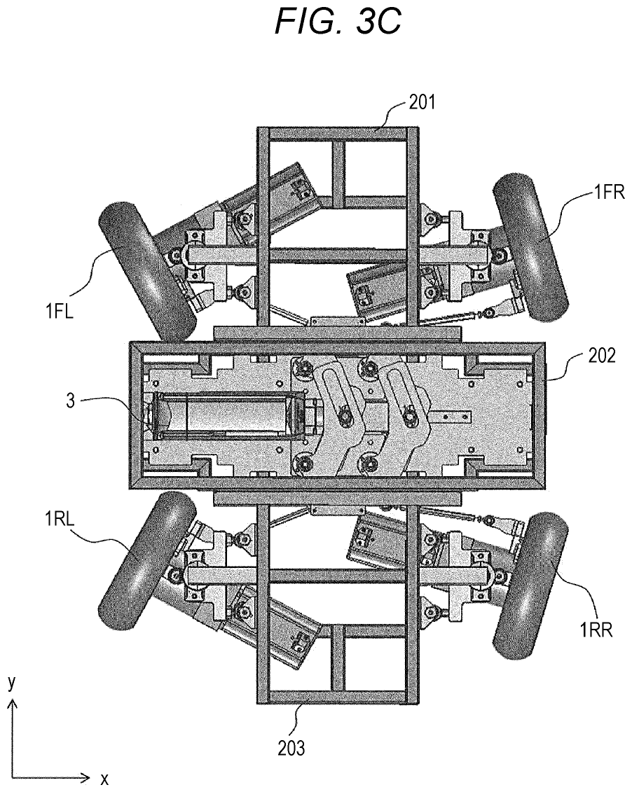

FIGS. 3A to 3C are schematic top views of main parts of the four-wheeled traveling device according to the embodiment. FIG. 3A illustrates a state of traveling straight, FIG. 3B illustrates a state of turning right, and FIG. 3C illustrates a state of turning left. Note that the main parts are not essential, and may be appropriately omitted or modified.

The four-wheeled traveling device includes four wheels including a left front wheel 1FL, a right front wheel 1FR, a left rear wheel 1RL, and a right rear wheel 1RR, and these may be collectively referred to as the “wheel 1”. Further, the four-wheeled traveling device includes a front frame body 201, a center frame body 202, and a rear frame body 203, and these may be collectively referred to as a “main body 200”.

At the time of traveling straight, a straight line connecting the centers of the left front wheel 1FL and the right front wheel 1FR and a straight line connecting the centers of the left rear wheel 1RL and the right rear wheel 1RR are parallel to each other. Hereinafter, this direction may be referred to as an x direction for convenience. A straight line connecting the centers of the left front wheel 1FL and the left rear wheel 1RL and a straight line connecting the centers of the right front wheel 1FR and the right rear wheel 1RR are parallel to each other. Hereinafter, this direction may be referred to as a y direction for convenience. The x direction and the y direction are orthogonal to each other.

As illustrated in FIG. 3A, at the time of traveling straight, all of the left front wheel 1FL, the right front wheel 1FR, the left rear wheel 1RL, and the right rear wheel 1RR are parallel to the y direction.

As illustrated in FIG. 3B, at the time of turning right, the left front wheel 1FL and the right front wheel 1FR face right with respect to the main body 200, and the left rear wheel 1RL and the right rear wheel 1RR face left with respect to the main body 200. In other words, the left front wheel 1FL and the right front wheel 1FR rotate clockwise in the horizontal plane. On the other hand, the left rear wheel 1RL and the right rear wheel 1RR rotate counterclockwise in the horizontal plane.

As illustrated in FIG. 3C, at the time of turning left, the left front wheel 1FL and the right front wheel 1FR face left with respect to the main body 200, and the left rear wheel 1RL and the right rear wheel 1RR face right with respect to the main body 200. In other words, the left front wheel 1FL and the right front wheel 1FR rotate counterclockwise in the horizontal plane. On the other hand, the left rear wheel 1RL and the right rear wheel 1RR rotate clockwise in the horizontal plane.

In the present embodiment, one feature is that such steering of traveling straight, turning right, and turning left is performed using one electric linear actuator 3 (linear motion cylinder), more specifically, the linear motion of one electric linear actuator 3 is converted into rotational motion of the left front wheel 1FL, the right front wheel 1FR, the left rear wheel 1RL, and the right rear wheel 1RR in the horizontal plane. A mechanism for steering in this manner will be described.

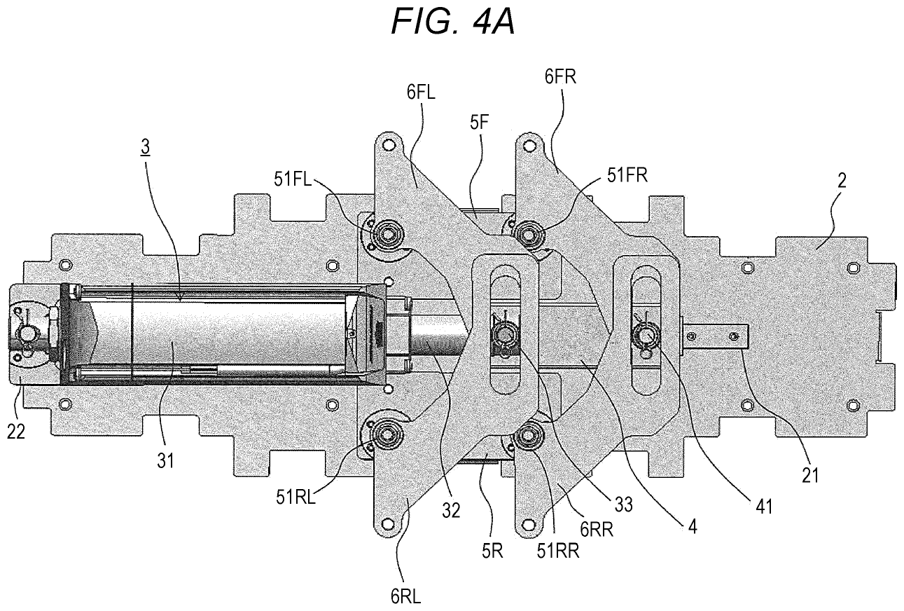

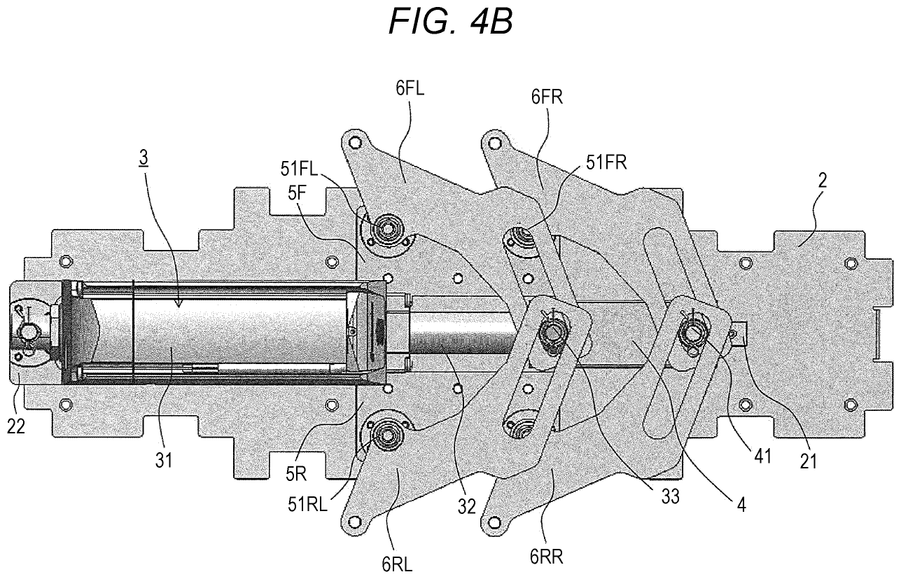

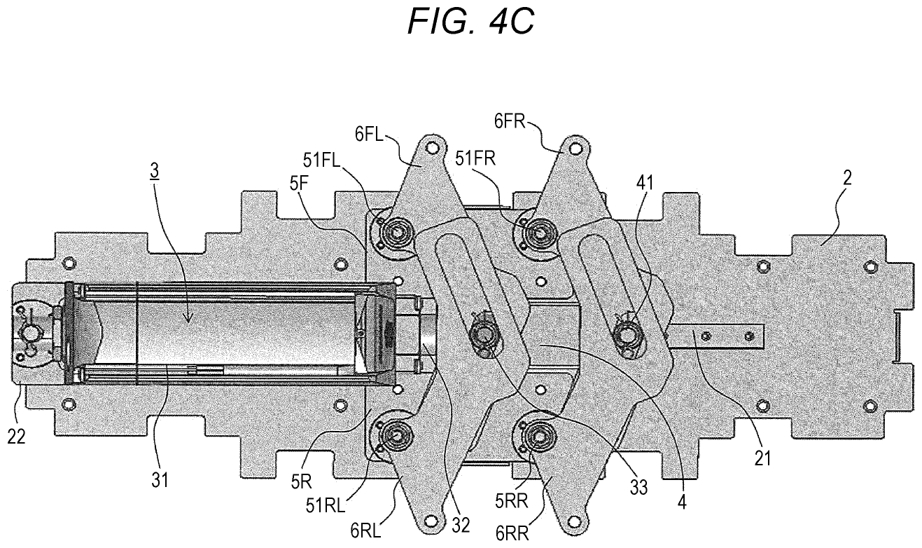

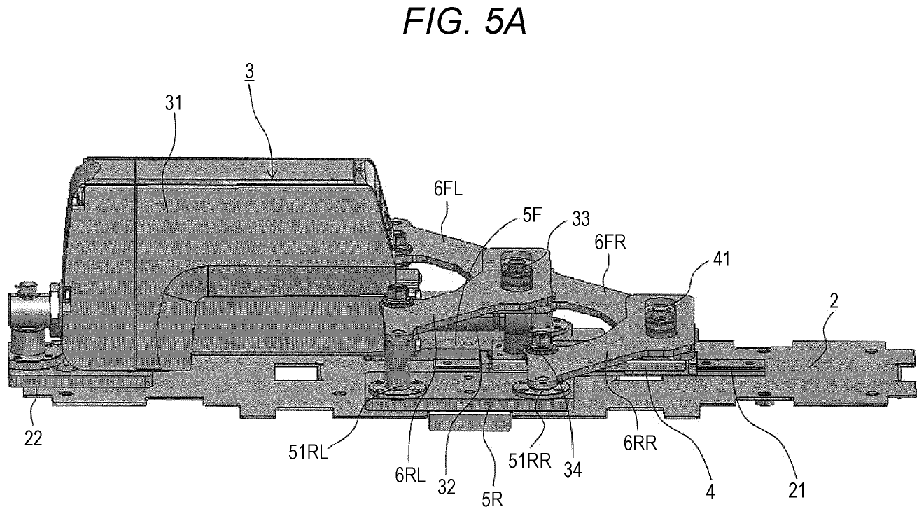

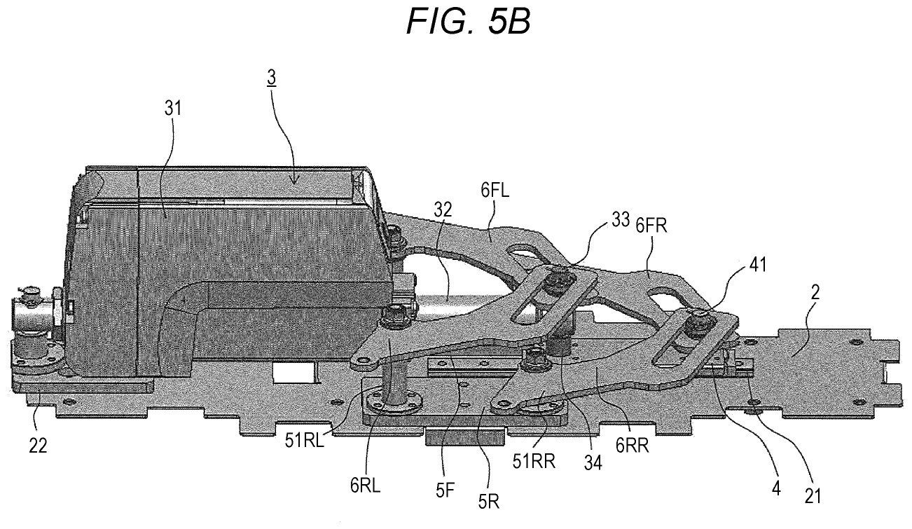

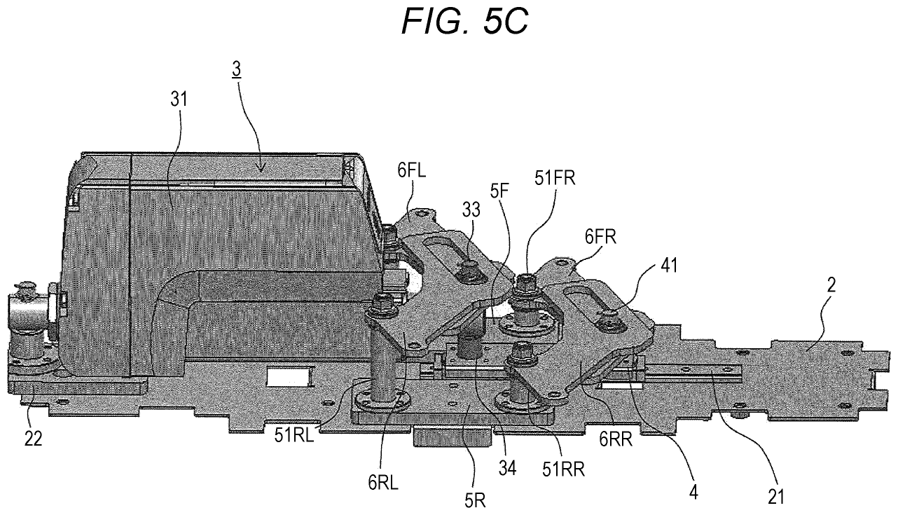

As illustrated in schematic top views in FIGS. 4A (at the time of traveling straight), 4B (at the time of turning right), and 4C (at the time of turning left), and in schematic perspective views in FIGS. 5A (at the time of traveling straight), 5B (at the time of turning right), and 5C (at the time of turning left), the four-wheeled traveling device includes a floor plate 2, an electric linear actuator 3 (hereinafter, simply referred to as the “actuator 3”), a steering link bridge 4 (hereinafter, simply referred to as the “bridge 4”), and two steering link mounts 5F and 5R (hereinafter, simply referred to as the “mounts 5F and 5R”).

The floor plate 2 is fixed to the center frame body 202 (not illustrated in FIG. 4, see FIG. 3A) of the four-wheeled traveling device. A linear guide 21 extending in the x direction and an actuator mount 22 are fixedly disposed on the floor plate 2.

The actuator 3 is fixed on the floor plate 2. More specifically, the actuator 3 has a main body portion 31 fixed on the actuator mount 22 on the left side of the floor plate 2, and a rod 32 extending and contracting in the x direction. Preferably, the extension and contraction of the rod 32 are automatically controlled by the controller 102 based on the image of the camera 100 (without instruction of an operator). Near the tip of the rod 32, an upward shaft 33 and a downward connecting member 34 are provided.

The rod 32 preferably extends and contracts not in an oblique direction but in the x direction (in the horizontal plane), so that the four-wheeled traveling device can be downsized. As described later, the rod 32 is at a predetermined reference position (for example, in the middle between the most extended state and the most contracted state,) at the time of traveling straight, extends to the right side in the x direction from the reference position at the time of turning right, and contracts to the left side in the x direction from the reference position at the time of turning left.

The bridge 4 extends in the x direction. A vertical cross section of the bridge 4 has a downward U shape. The bridge 4 is disposed so as to cover the linear guide 21 of the floor plate 2 (to be fitted into the linear guide 21).

As illustrated in FIG. 5A and the like, a left portion of the bridge 4 is connected to the rod 32 of the actuator 3 via the connecting member 34. Therefore, the bridge 4 moves in the left-right direction (x direction) along the linear guide 21 in conjunction with the extension and contraction of the rod 32.

The upward shaft 41 is provided on a right portion of the bridge 4. As illustrated in FIG. 5A and the like, an upper end of the shaft 41 is preferably not at the same height as an upper end of the shaft 33 of the rod 32, and is assumed to be at a low position in the present embodiment. The shaft 41 of the bridge 4 is located on the right side of the shaft 33 of the rod 32. That is, the shaft 33 corresponds to the left front wheel 1FL and the left rear wheel 1RL, and the shaft 41 corresponds to the right front wheel 1FR and the right rear wheel 1RR.

The mounts 5F and 5R are fixed on the floor plate 2 and do not interlock with the extension and contraction of the rod 32. As illustrated in FIG. 4A and the like, two shafts 51FL and 51FR corresponding to the left front wheel 1FL and the right front wheel 1FR are provided on the mount 5F on the front side (for the front wheel). In the present embodiment, since the upper end of the shaft 41 of the bridge 4 is lower than the upper end of the shaft 33 of the rod 32, the shaft 51FL corresponding to the left front wheel 1FL is preferably higher than the shaft 51FR corresponding to the right front wheel 1FR. Specifically, the shaft 51FL has substantially the same height as the shaft 33, and the shaft 51FR has substantially the same height as the shaft 41.

Similarly, two shafts 51RL and 51RR corresponding to the left rear wheel 1RL and the right rear wheel 1RR are provided on the mount 5R on the rear side (for the rear wheel). In the present embodiment, since the upper end of the shaft 41 of the bridge 4 is lower than the upper end of the shaft 33 of the rod 32, the shaft 51RL corresponding to the left rear wheel 1RL is preferably higher than the shaft 51RR corresponding to the right rear wheel 1RR. Specifically, the shaft 51RL has substantially the same height as the shaft 33, and the shaft 51RR has substantially the same height as the shaft 41.

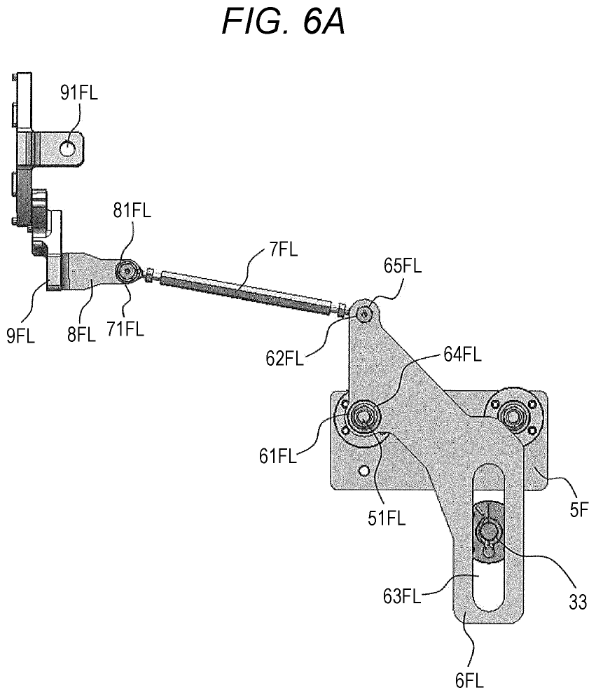

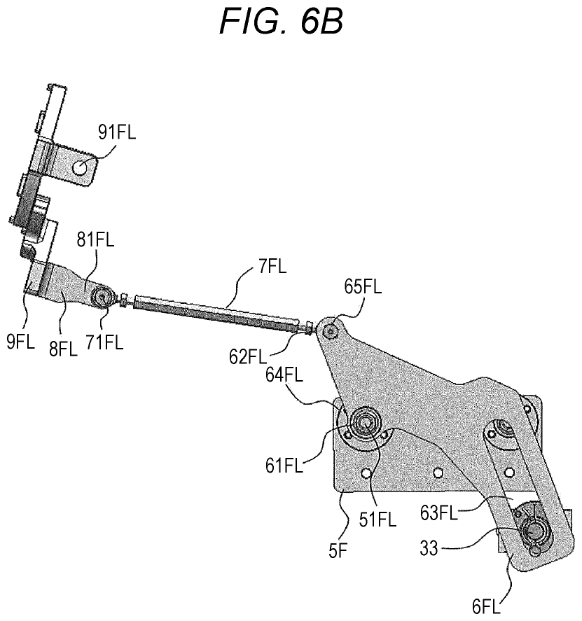

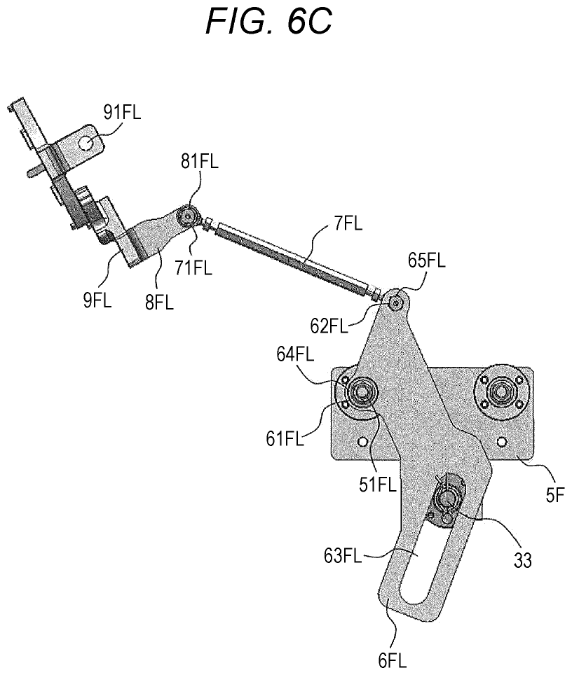

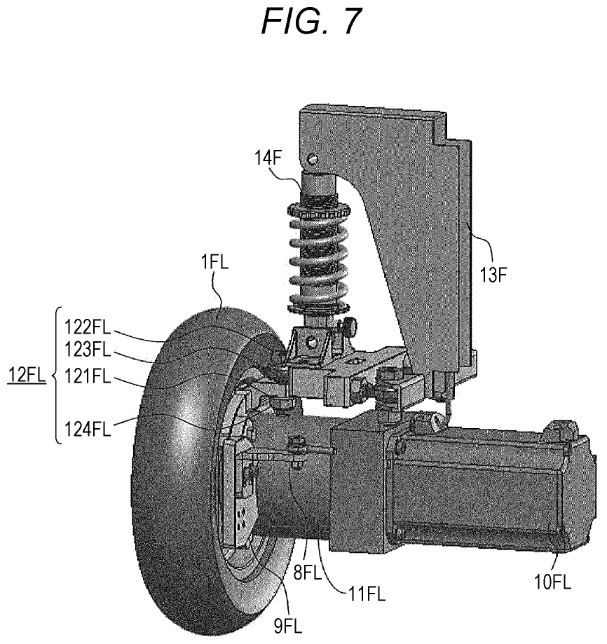

Steering link plates 6FL, 6FR, 6RL, and 6LL (hereinafter, simply referred to as the “links 6FL, 6FR, 6RL, and 6LL”) illustrated in FIGS. 4A to 4C and FIGS. 5A to 5C will be described below with reference to FIGS. 6A to 6C.

The four-wheeled traveling device includes four links 6FL, 6FR, 6RL, and 6LL, four tie rods 7FL, 7FR, 7RL, and 7LL, four knuckles 8FL, 8FR, 8RL, and 8LL, and four joints 9FL, 9FR, 9RL, and 9RR corresponding to the individual wheels, and schematic perspective views of what is related to the left front wheel 1FL are illustrated in FIGS. 6A (at the time of traveling straight), 5B (at the time of turning right), and 5C (at the time of turning left). In the present specification, FL, FR, RL, and RR at the end of reference numerals correspond to the left front wheel 1FL, the right front wheel 1FR, the left rear wheel 1RL, and the right rear wheel 1RR. In addition, in a case where FL or the like is not added to the end as in the “link 6”, this means a generic term of the members.

On the left side of the link 6FL, two small holes (rear small hole 61FL and front small hole 62FL) arranged in the y direction at the time of traveling straight are provided. The shaft 51FL of the mount 5F is rotatably fitted into the rear small hole 61FL through a bearing 64FL. One end of the tie rod 7FL is fitted into the front small hole 62FL through a bearing 65FL (preferably, a rod end bearing).

On the right side of the link 6FL, a slit 63FL (elongated hole) extending in the y direction at the time of traveling straight is provided. The shaft 33 of the rod 32 is fitted into the slit 63FL. The shaft 33 can slide in the slit 63FL in conjunction with the extension and contraction motion of the rod 32. As a result, the link 6FL rotates in the horizontal plane by the shaft 33 in conjunction with the extension and contraction of the actuator 3.

The link 6FL (in cooperation with the tie rod 7FL and the knuckle 8FL to be described later) converts linear motion (extension and contraction) of the actuator 3 in the x direction into rotational motion of the left front wheel 1FL in the horizontal plane.

The tie rod 7FL is a rod-like member, and a right end thereof is fitted into the small hole 62FL of the link 6FL, and a left end thereof is fitted into the small hole 81FL of the knuckle 8FL described later through the bearing 71FL. At the time of traveling straight, the tie rod 7FL is not parallel to the x direction, and the side of the knuckle 8FL (left side) is located in front of the side of the link 6FL (right side).

In the knuckle 8FL, the small hole 81FL is provided in a right tip portion, and a left end of the tie rod 7 is fitted through the bearing 71FL. The left side of the knuckle 8FL is connected to the joint 9FL.

The joint 9FL is located behind the center of the left front wheel 1FL. The rear side of the joint 9FL is connected to the knuckle 8FL. The joint 9FL is provided with a small hole 91FL. As will be described later with reference to FIG. 6, the joint 9FL is connected to the front frame body 201 via another member.

Although the link 6FL, the tie rod 7FL, the knuckle 8FL, and the joint 9FL for the left front wheel 1FL have been described above, these are substantially similar for the left rear wheel 1RL, the right front wheel 1FR, and the right rear wheel 1RR. However, not the shaft 33 of the rod 32 but the shaft 41 of the bridge 4 is slidably fitted into the slits 63FR and 63RR of the links 6FR and 6RR for the right front wheel 1FR and the right rear wheel 1RR. As a result, the links 6FR and 6RR rotate in the horizontal plane by the shaft 41 in conjunction with the extension and contraction of the actuator 3.

As illustrated in FIGS. 4A to 4C and FIGS. 5A to 5C, the link 6RL for the left rear wheel 1RL is disposed to overlap the link 6FL for the left front wheel 1FL. Therefore, the latter is located slightly above (by the thickness of the link 6FL). That is, these links 6FL and 6RL are on substantially the same horizontal plane. As illustrated in FIG. 4A, the slit 63FL of the link 6FL substantially overlaps the slit 63RL of the link 6RL at the time of traveling straight.

Similarly, the link 6RR for the right rear wheel 1RR is disposed to overlap the link 6FR for the right front wheel 1FR. That is, these links 6FR and 6RR are on substantially the same horizontal plane.

The upper end of the shaft 41 of the bridge 4 is located higher than the upper end of the shaft 33 of the rod 32. Therefore, as illustrated in FIG. 5A, the links 6FL and 6RL into which the shaft 33 is fitted are located higher than the links 6FR and 6RR into which the shaft 41 is fitted. As such, the links 6FL and 6RL and the links 6FR and RR are preferably shifted from each other in the height direction. As a result, the links 6FL and 6RL and the links 6FR and RR rotate in different horizontal planes. Therefore, even if the links 6FL and 6RL and the links 6FR and RR are disposed adjacent to each other, they do not interfere with each other at the time of turning right or left, so that the four-wheeled traveling device can be downsized.

Here, in order to reduce the manufacturing cost, the link 6FL for the left front wheel 1FL preferably has the same shape as the link 6FR for the right front wheel 1FR. Similarly, the link 6RL for the left rear wheel 1RL preferably has the same shape as the link 6RR for the right rear wheel 1RR. Note that the same shape herein is not necessarily strict matching, and means that manufacturing can be performed in the same process.

The link 6RL for the left rear wheel 1RL preferably has a shape obtained by inverting the link 6FL for the left front wheel 1FL with respect to the x direction (or the link 6RL can be used by being vertically inverted in the same shape). The link 6RR for the right rear wheel 1RR preferably has a shape obtained by inverting the link 6FR for the right front wheel 1FR with respect to the x direction (or the link 6RR can be used by being vertically inverted in the same shape). That is, all the four links 6 may have the same shape, or at least two of the four links may have the same shape. In this way, the manufacturing cost can be reduced as compared with a case where the four links have different shapes. At the time of traveling straight, the link 6, the tie rod 7, and the knuckle 8 are preferably disposed symmetrically in a front-rear direction with the rod 32 as an axis.

Further, the four-wheeled traveling device includes four motors 10FL, 10FR, 10RL, and 10RR, four gear boxes 11FL, 11FR, 11RL, and 11RR, four king pins 12FL, 12FR, 12RL, and 12RR, four suspension arms 13FL, 13FR, 13RL, and 13RR, and four suspensions 14FL, 14FR, 14RL, and 14RR corresponding to the individual wheels, and a schematic perspective view of what is related to the left front wheel 1FL is illustrated in FIG. 7.

An output shaft of the motor 10FL is connected to the gear box 11FL, and an output shaft of the gear box 11FL is connected to the left front wheel 1FL. The rotation of the motor 10FL is decelerated at a predetermined ratio by the gear box 11FL and transmitted to the left front wheel 1FL, and the left front wheel 1FL rotates. The gear box 11FL is fixed to the joint 9FL. The motor 10FL, the gear box 11FL, and the left front wheel 1FL are integrated.

The king pin 12FL includes a pin main body 121FL, a bolt (pin head) 122FL, a bearing 123FL, and a nut 124FL.

The pin main body 121FL passes through the small hole 91F (see FIGS. 5A to 5C) provided in the joint 9FL, and is fixed by the bolt 122FL and the nut 124FL. The bearing 123FL is fixed to the front frame body 201 (see FIGS. 3A to 3C) via the suspension arm 13FL.

With the above configuration, in conjunction with the movement of the knuckle 8FL, the motor 10FL, the gear box 11FL, and the left front wheel 1FL that have been integrated moves rotationally about the king pin 12FL in the horizontal plane with respect to the front frame body 201.

An upper end of the suspension 14FL is fixed to the front frame body 201 via the suspension arm 13FL, and a lower end thereof is connected to the joint 9FL. By connecting one end of the tie rod 7FL and the link 6FL via the rod end bearing 65FL, a degree of freedom is given to the motion of the left front wheel 1FL in the vertical direction, and the restriction on the steering mechanism can be reduced.

The operation of the four-wheeled traveling device is as follows.

As illustrated in FIG. 4A and the like, the mounts 5F and 5R are fixed to the floor plate 2 and do not interlock with the extension and contraction of the rod 32. Therefore, the positions of the shafts 51FL, 51FR, 51RL, and 51RR provided on the mounts 5F and 5R are fixed, so that the position of the small hole 61 (see FIG. 6A and the like) of the link 6 is also fixed.

On the other hand, since the bridge 4 moves in conjunction with the extension and contraction of the rod 32, the shaft 33 provided on the rod 32 and the shaft 41 provided on the bridge 4 move in conjunction with the extension and contraction of the rod 32. As a result, the link 6 also moves. More specifically, the link 6 rotates in the horizontal plane about the position of the small hole 61 whose position is fixed. As a result, the tie rods 7 connected to the links 6 and the knuckles 8 move, and the direction of the wheel is controlled.

Specifically, as illustrated in FIGS. 3A, 4A, and 5A, the rod 32 of the actuator 3 is controlled by the controller 102 to be at a predetermined reference position at the time of traveling straight. At this time, when the shaft 33 travels straight, the left front wheel 1FL, the right front wheel 1FR, the left rear wheel 1RL, and the right rear wheel 1RR are all parallel to the y direction.

As illustrated in FIGS. 3B, 4B, and 5B, at the time of turning right, the rod 32 of the actuator 3 is controlled by the controller 102 to be in a state of extending rightward from the reference position. The bridge 4, the link 6, the tie rod 7, and the knuckle 8 move in conjunction with the rod 32 extending rightward.

Specifically, when the rod 32 extends rightward, the shaft 33 relatively moves to the rear wheel side of the slit 63FL of the link 6FL for the left front wheel 1FL, and the link 6FL rotates counterclockwise about the position of the small hole 61FL (see FIG. 6B). Thereby, the small hole 62FL to which the tie rod 7FL has been connected moves to the left side, so that the knuckle 8FL connected to the tie rod 7FL also moves to the left side. Therefore, the left front wheel 1FL, the gear box 11FL, and the motor 10FL integrally rotate clockwise in the horizontal plane about the king pin 12FL (small hole 91FL of the joint 9FL). As a result, the left front wheel 1FL faces right.

When the rod 32 extends rightward, the shaft 33 relatively moves to the rear wheel side of the slit 63FR of the link 6FR for the right front wheel 1FR, and the link 6FR rotates counterclockwise about the position of the small hole 61FR. Thereby, the small hole 62FR to which the tie rod 7FR has been connected moves to the left side, so that the knuckle 8FR connected to the tie rod 7FR also moves to the left side. Therefore, the right front wheel 1FR, the gear box 11FR, and the motor 10FR integrally rotate clockwise in the horizontal plane about the king pin 12FR (small hole 91FR of the joint 9FR). As a result, the right front wheel 1FR faces right.

When the rod 32 extends rightward, the shaft 33 relatively moves to the front wheel side of the slit 63RL of the link 6RL for the left rear wheel 1RL, and the link 6RL rotates clockwise about the position of the small hole 61RL. Thereby, the small hole 62RL to which the tie rod 7RL has been connected moves to the left side, so that the knuckle 8RL connected to the tie rod 7RL also moves to the left side. Therefore, the left rear wheel 1RL, the gear box 11RL, and the motor 10RL integrally rotate counterclockwise in the horizontal plane about the king pin 12RL (small hole 91RL of the joint 9RL). As a result, the left rear wheel 1RL faces right.

When the rod 32 extends rightward, the shaft 33 relatively moves to the front wheel side of the slit 63RR of the link 6RR for the right rear wheel 1RR, and the link 6RR rotates clockwise about the position of the small hole 61RR. Thereby, the small hole 62RR to which the tie rod 7RR has been connected moves to the left side, so that the knuckle 8RR connected to the tie rod 7RR also moves to the left side. Therefore, the right rear wheel 1RR, the gear box 11RR, and the motor 10RR integrally rotate counterclockwise in the horizontal plane about the king pin 12RR (small hole 91RR of the joint 9RR). As a result, the right rear wheel 1RR faces right.

As described above, in conjunction with the rod 32 extending rightward, the left front wheel 1FL and the right front wheel 1FR rotate clockwise in the horizontal plane and face right, and the left rear wheel 1RL and the right rear wheel 1RR rotate counterclockwise in the horizontal plane and face left.

Next, a left turn will be described. As illustrated in FIG. 3C, the rod 32 of the actuator 3 is controlled by the controller 102 to be in a state of contracting leftward from the reference position at the time of turning left. The bridge 4, the link 6, the tie rod 7, and the knuckle 8 move in conjunction with the rod 32 contracting leftward.

Specifically, when the rod 32 contracts leftward, the shaft 33 relatively moves to the front wheel side of the slit 63FL of the link 6FL for the left front wheel 1FL, and the link 6FL rotates clockwise about the position of the small hole 61FL (see FIG. 6C). Thereby, the small hole 62FL to which the tie rod 7FL has been connected moves to the right side, so that the knuckle 8FL connected to the tie rod 7FL also moves to the right side. Therefore, the left front wheel 1FL, the gear box 11FL, and the motor 10FL integrally rotate counterclockwise in the horizontal plane about the king pin 12FL (small hole 91FL of the joint 9FL). As a result, the left front wheel 1FL faces left.

When the rod 32 contracts leftward, the shaft 33 relatively moves to the front wheel side of the slit 63FR of the link 6FR for the right front wheel 1FR, and the link 6FR rotates clockwise about the position of the small hole 61FR. Thereby, the small hole 62FR to which the tie rod 7FR has been connected moves to the right side, so that the knuckle 8FR connected to the tie rod 7FR also moves to the right side. Therefore, the right front wheel 1FR, the gear box 11FR, and the motor 10FR integrally rotate counterclockwise in the horizontal plane about the king pin 12FR (small hole 91FR of the joint 9FR). As a result, the right front wheel 1FR faces left.

When the rod 32 contracts leftward, the shaft 33 relatively moves to the rear wheel side of the slit 63RL of the link 6RL for the left rear wheel 1RL, and the link 6RL rotates counterclockwise about the position of the small hole 61RL. Thereby, the small hole 62RL to which the tie rod 7RL has been connected moves to the right side, so that the knuckle 8RL connected to the tie rod 7RL also moves to the right side. Therefore, the left rear wheel 1RL, the gear box 11RL, and the motor 10RL integrally rotate clockwise in the horizontal plane about the king pin 12RL (small hole 91RL of the joint 9RL). As a result, the left rear wheel 1RL faces right.

When the rod 32 contracts leftward, the shaft 33 relatively moves to the rear wheel side of the slit 63RR of the link 6RR for the right rear wheel 1RR, and the link 6RR rotates counterclockwise about the position of the small hole 61RR. Thereby, the small hole 62RR to which the tie rod 7RR has been connected moves to the right side, so that the knuckle 8RR connected to the tie rod 7RR also moves to the right side. Therefore, the right rear wheel 1RR, the gear box 11RR, and the motor 10RR integrally rotate clockwise in the horizontal plane about the king pin 12RR (small hole 91RR of the joint 9RR). As a result, the right rear wheel 1RR faces left.

As described above, in conjunction with the rod 32 contracting leftward, the left front wheel 1FL and the right front wheel 1FR rotate counterclockwise in the horizontal plane and face left, and the left rear wheel 1RL and the right rear wheel 1RR rotate clockwise in the horizontal plane and face right.

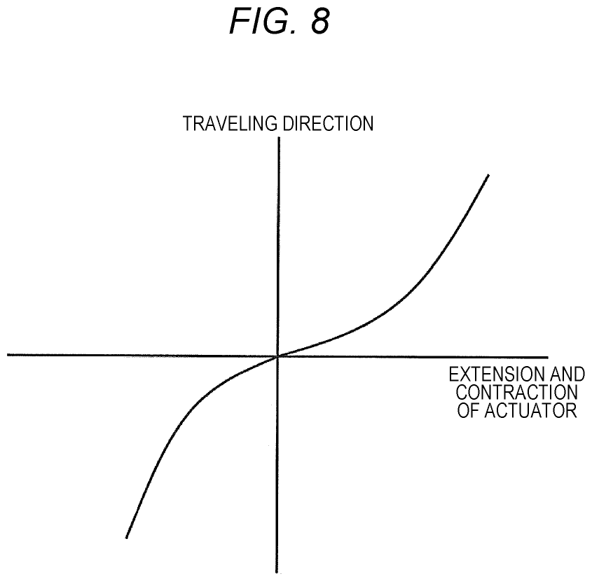

FIG. 8 is a diagram schematically illustrating a relation between the extension and contraction of the rod 32 and the traveling direction of the four-wheeled traveling device. A horizontal axis represents a position of the rod 32, “0” represents a reference position, positive represents a state of extending rightward from the reference position, and negative represents a state of contracting leftward from the reference position. A vertical axis represents the traveling direction, and for convenience, “0” represents traveling straight, positive represents an angle of turning right, and negative represents an angle of turning left.

As illustrated in the drawing, the rod 32 bends greatly rightward as it extends rightward, and the rod 32 bends greatly leftward as it contracts leftward.

Here, the traveling direction may not be bilaterally symmetrical with respect to the reference position. In particular, in the case of automatic traveling, since the controller 102 controls the actuator 3 instead of a person, asymmetry does not cause a problem. It is also possible to cause the traveling direction to be bilaterally symmetrical with respect to the reference position by devising the shape (for example, the shape and position of the slit 63 and the positions of the small holes 61 and 62) of the link 6. However, by causing the link 6 to have the same shape and causing the link 6 to have a symmetrical shape, the manufacturing cost can be suppressed.

Based on the above description, a person skilled in the art may be able to conceive additional effects and various modifications of the present invention, but aspects of the present invention are not limited to the individual embodiments described above. Various additions, modifications, and partial deletions can be made without departing from the conceptual idea and spirit of the present invention derived from the content defined in the claims and equivalents thereof.

For example, what is described as one member in the present specification (including what is drawn as one member in the drawings) may be realized by a plurality of members. Conversely, what is described as a plurality of members in the present specification (including what is drawn as a plurality of members in the drawings) may be realized by one member.

In addition, not all the matters described in the present specification are essential requirements. In particular, matters described in the present specification and not described in the claims can be regarded as any additional matters.

It should be noted that the present applicant is merely aware of the invention disclosed in the document in the column of “Citation List” in the present specification, and the present invention is not necessarily intended to solve the problem in the invention disclosed in the document. The problem to be solved by the present invention should be recognized in consideration of the entire specification. For example, in the present specification, in a case where there is a description that a predetermined effect is exhibited by a specific configuration, it can be said that the problem of reversing the predetermined effect is solved. However, such a specific configuration is not necessarily an essential requirement.

### REFERENCE SIGNS LIST

1 wheel
1FL left front wheel
1FR right front wheel
1RL left rear wheel
1RR right rear wheel
2 floor plate
21 linear guide
22 actuator mount
3 actuator (electric linear actuator)
31 main body portion
32 rod
33 shaft
34 connecting member
4 bridge (steering link bridge)
41 shaft
5 mount (steering link mount)
51 shaft
6 link (steering link plate)
61, 62 small hole
63 slit
64, 65 bearing
7 tie rod
71 bearing
8 knuckle
81 small hole
9 joint
91 small hole
10 motor
11 gear box
12 king pin
121 pin main body
122 bolt
123 bearing
124 nut
13 suspension arm
14 suspension
100 camera
101 memory
102 controller
103 tablet terminal
201 front frame body
202 center frame body
203 rear frame body

1. A four-wheeled traveling device that performs steering by converting extension and contraction motion of one linear actuator into rotational motion of a first front wheel, a second front wheel, a first rear wheel, and a second rear wheel in a horizontal plane via a link, wherein
the linear actuator extends and contracts in parallel with a line connecting the first front wheel and the second front wheel.

2. A four-wheeled traveling device that performs steering by converting extension and contraction motion of one linear actuator into rotational motion of a first front wheel, a second front wheel, a first rear wheel, and a second rear wheel in a horizontal plane via a link, wherein
at least two of a link for the first front wheel, a link for the second front wheel, a link for the first rear wheel, and a link for the second rear wheel have an identical shape.

3. The four-wheeled traveling device according to claim 2, wherein the link for the first front wheel, the link for the second front wheel, the link for the first rear wheel, and the link for the second rear wheel all have an identical shape.

4. A four-wheeled traveling device that performs steering by converting extension and contraction motion of one linear actuator into rotational motion of a first front wheel, a second front wheel, a first rear wheel, and a second rear wheel in a horizontal plane via a link, wherein
a link for the first front wheel and a link for the first rear wheel are located substantially on a first horizontal plane and rotate in the first horizontal plane,
a link for the second front wheel and a link for the second rear wheel are located substantially on a second horizontal plane and rotate in the second horizontal plane, and
the first horizontal plane and the second horizontal plane are different from each other.

5. The four-wheeled traveling device according to claim 1, comprising:
the first front wheel;
the second front wheel;
the first rear wheel located behind the first front wheel;
the second rear wheel located behind the second front wheel;
the linear actuator; and
the link, wherein
the link includes a first link for the first front wheel, a second link for the second front wheel, a third link for the first rear wheel, and a fourth link for the second rear wheel.

6. The four-wheeled traveling device according to claim 5, wherein
the linear actuator has a rod that extends and contracts in a first direction,
the four-wheeled traveling device comprises a bridge that moves in the first direction in conjunction with the rod,
the first link and the third link rotate in a horizontal plane in conjunction with the extension and contraction of the linear actuator by a first shaft provided in the rod, and
the second link and the fourth link rotate in a horizontal plane in conjunction with the extension and contraction of the linear actuator by a second shaft provided in the bridge.

7. The four-wheeled traveling device according to claim 6, wherein
a slit is provided in each of the first link and the third link, and
the first shaft is slidably fitted into the slits of the first link and the third link.

8. The four-wheeled traveling device according to claim 6, wherein
a slit is provided in each of the second link and the fourth link, and
the second shaft is slidably fitted into the slits of the second link and the fourth link.

9. The four-wheeled traveling device according to claim 7, wherein the slit extends in parallel with a line connecting the first front wheel and the first rear wheel in a state of traveling straight.

10. The four-wheeled traveling device according to claim 5, wherein
each of the first to fourth links is provided with a small hole into which a third shaft that does not interlock with the rod is fitted, and
each of the first to fourth links rotates in a horizontal plane about the small hole.

11. The four-wheeled traveling device according to claim 5, wherein
the linear actuator is disposed closer to the first front wheel and the first rear wheel than a line connecting centers of the first front wheel and the second front wheel and centers of the first rear wheel and the second rear wheel,
when the rod of the linear actuator is at a reference position, the four-wheeled traveling device travels straight,
when the rod of the linear actuator extends from the reference position, the four-wheeled traveling device bends toward the second front wheel and the second rear wheel, and
when the rod of the linear actuator contracts from the reference position, the four-wheeled traveling device bends toward the first front wheel and the first rear wheel.

12. The four-wheeled traveling device according to claim 5, comprising:
a camera; and
a controller that automatically controls the extension and contraction of the linear actuator based on an image of the camera.
